(19) United States
(12) Patent Application Publication
(10) Pub. No.: US 2023/0176848 A1
(43) Pub. Date: Jun. 8, 2023

(54) TRANSFORMATION OF A COMPUTING ENVIRONMENT FROM ONE TECHNOLOGICAL STATE TO ANOTHER TECHNOLOGICAL STATE

(71) Applicant: KYNDRYL, INC., New York, NY (US)

(72) Inventors: Laxmikantha Sai Nanduru, R K Puram Post (IN); Clea Zolotow, Key West, FL (US); Robert Dagley, Broadway (GB); Nick Drouet, London (GB); Anil Kumar Narigapalli, Hyderabad (IN); Sam McConnell, Goodyear, AZ (US)

(21) Appl. No.: 17/643,012

(22) Filed: Dec. 7, 2021

(51) Int. Cl. G06F 8/65; G06F 8/71

(52) U.S. Cl. CPC G06F 8/65; G06F 8/71

(57) ABSTRACT

A computing environment is transformed from one technological state to another technological state. Data relating to the computing environment is obtained, and the data includes life-cycle information of one or more computing resources of the computing environment and one or more requests of an entity to use the computing environment. Based at least on the data that is obtained, a plurality of sets of transformation tasks to be used to transform a selected infrastructure of the computing environment from one technological state to another technological state is automatically derived. Based on at least one set of transformation tasks of the plurality of sets of transformation tasks, one or more actions is taken to transform the selected infrastructure from the one technological state to the other technological state.

### BACKGROUND

One or more aspects relate, in general, to processing within a computing environment, and in particular, to facilitating upgrading selected aspects of the computing environment.

In today's information age, large enterprises that wish to maintain currency of their information technology (IT) infrastructure and application environment contend with a vast amount of computing resources, including software applications. The applications may be running on a variety of operating systems and there may be multiple versions coexisting with varying levels of cross compatibility. When it comes to software upgrades, usually applications and operating systems have to be upgraded in conjunction with each other, on supported hardware platforms. This requires a gathering of data of all the systems, identifying the software packages installed, and manually perusing through the compatibility information for each installed software product.

### SUMMARY

Shortcomings of the prior art are overcome, and additional advantages are provided through the provision of a computer program product to facilitate processing within a computing environment. The computer program product includes one or more computer readable storage media and program instructions collectively stored on the one or more computer readable storage media to perform a method. The method includes obtaining data relating to the computing environment, in which the data includes life-cycle information of one or more computing resources of the computing environment and one or more requests of an entity to use the computing environment. Based at least on the data that is obtained, a plurality of sets of transformation tasks to be used to transform a selected infrastructure of the computing environment from one technological state to another technological state is automatically derived. Based on at least one set of transformation tasks of the plurality of sets of transformation tasks, one or more actions is taken to transform the selected infrastructure from the one technological state to the other technological state.

Computer-implemented methods and computer systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more aspects of the present invention;

FIGS. 2A-2G depict one example of processing to transform a computing environment from one technological state to another technological state, in accordance with one or more aspects of the present invention;

FIG. 3A depicts one example of a directed acyclic graph used in accordance with one or more aspects of the present invention;

FIGS. 3B-3D depict examples of nodes for the directed acyclic graph of FIG. 3A, in accordance with one or more aspects of the present invention;

FIG. 4 depicts another example of a directed acyclic graph used in accordance with one or more aspects of the present invention;

FIG. 5 depicts one example of a tree diagram used in risk analysis, in accordance with one or more aspects of the present invention;

FIG. 6 depicts one example of a risk profile of nodes, in accordance with one or more aspects of the present invention;

FIG. 7 depicts one example of a computing environment to incorporate and/or use one or more aspects of the present invention;

FIG. 8A depicts another example of a computing environment to incorporate and/or use one or more aspects of the present invention;

FIG. 8B depicts further details of the memory of FIG. 8A, in accordance with one or more aspects of the present invention;

FIG. 9 depicts one embodiment of a cloud computing environment, in accordance with one or more aspects of the present invention; and

FIG. 10 depicts one example of abstraction model layers, in accordance with one or more aspects of the present invention.

### DETAILED DESCRIPTION

In one or more aspects, a capability is provided to facilitate processing within a computing environment. In one example, the capability includes providing a mechanism to facilitate transformation of a computing environment from one technological state (e.g., a source state) to another technological state (e.g., a target state).

As indicated above, when it comes to application upgrades, typically applications and operating systems are to be upgraded in conjunction with each other, on supported hardware platforms. To accomplish this previously, data of all (or selected) systems is collected, the software packages installed are identified, and the compatibility information for each installed software product is manually perused, which is time-consuming and error prone. Additionally, several possible target states are to be considered (e.g., combinations of resources, e.g., operating systems and target application software versions) to develop upgrade plans. A ‘target state’ is, e.g., a set of software applications of specific versions in the upgraded environment. Based on how the applications (and/or other computing resources) in the source environment integrate and inter-operate with each other, the upgrade pathways could have varying paybacks by way of cost, time, migration path, etc. Therefore, there are choices to be made along the way for any combination of software products, since every product has an expiration date by which its upgrade to a supported version becomes imperative.

A compatibility impact, as well as the migration impact, may be considered to determine an optimal path, i.e., a correct or selected way of upgrading both singular workloads and rolled-up combinations of workloads. Note that some applications may only be compatible and interoperable in a migration of an operating system from version N-1 to N level (it implies that an operating system upgrade from version N-2 to N may need application upgrades as well).

If an application is upgraded without upgrading its corresponding interfacing application(s), there could be issues. For example, consider an application that includes multiple software components—middleware (e.g., software that acts as a bridge between an operating system and applications) and a database server running on a specific operating system, and the particular operating system version is going out of support. For such a scenario, the following is understood or considered, as examples: Potential operating system upgrade options (e.g., are multiple upgrade versions available, i.e., versions N-2, N-1, and N) and platform transformation options (e.g., legacy operating system to, e.g., a different operating system; compatibility of middleware and database server versions with each operating system upgrade option; interoperability of middleware and database server, if one is to be upgraded to a higher version along with the operating system; available life span for each operating system, middleware and database server versions (there is a minimal benefit in upgrading to N-1 version, if a related application component will go out of support in the near future forcing a second upgrade to version N soon); time, cost, effort, and risks of the upgrades; and benefits of upgrading to each of the potential versions, e.g., access to new features and functionality, life span of the version, cost optimization, etc. Additional, fewer and/or other considerations may pertain.

There could also be a scenario where one of the software components in the existing environment has no upgrade path and may need to be replaced with an equivalent alternate product, which adds its own set of challenges to the transformation decisions.

Thus, as can be understood, application component (and/or other computing resource) modernization is complex with multiple considerations, dimensions and impacts that are to be managed to successfully modernize (e.g., update) and transform the existing computing environment. Any misstep may result in failed projects, cost overruns and unanticipated system outages that can be devastating to an entity (e.g., business). Thus, in one or more aspects, various considerations are taken into account and a set of viable options is presented to realize the transformation objectives.

In one or more aspects, a capability is provided to transform a computing environment from one technological state to another technological state. As an example, at least one infrastructure of the computing environment is transformed. For instance, an application infrastructure of the computing environment is transformed from a source state to a target state by, e.g., transforming one or more applications from the source state to the target state. In one or more aspects, the transformation is underpinned in cognitive analysis of workload characteristics, application component life-cycle considerations and entity request (e.g., requirements); uses requirements and variables as predictors for, e.g., multiple linear regression analysis and optimization analysis to develop optimal transformation pathways (e.g., sets of transformation tasks); provides for impact analysis of transformative actions, so outcomes are predictable (e.g., the impact of upgrading a select resource in a software stack on the overall system, such as performance, stability, availability, etc.); provides for generating multiple transformation models that can be mutually compared to determine optimal pathways using one or more prioritized factors; uses directed acyclic graphs (DAGs), as an example, to denote many-to-many relationship maps of variables along with associated risk profiles for a superior decision process and avoiding execution pitfalls; and/or uses, e.g., a Hidden Markov model for non-linear distributions in machine learning for risk modeling for various transformation pathways.

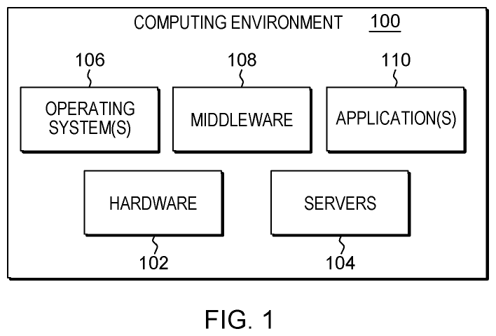

One example of a computing environment that may be transformed from one technological state to another technological state is depicted in FIG. 1. As an example, computing environment 100 includes a plurality of computing resources or components including, for instance, hardware 102 (e.g., processors, memory, etc.); one or more servers 104, such as one or more database servers and/or other servers, which may be implemented in hardware (e.g., hardware 102) and/or software; one or more operating systems 106; middleware 108; and one or more applications 110. Additional, fewer and/or other computing resources may be included in computing environment 100.

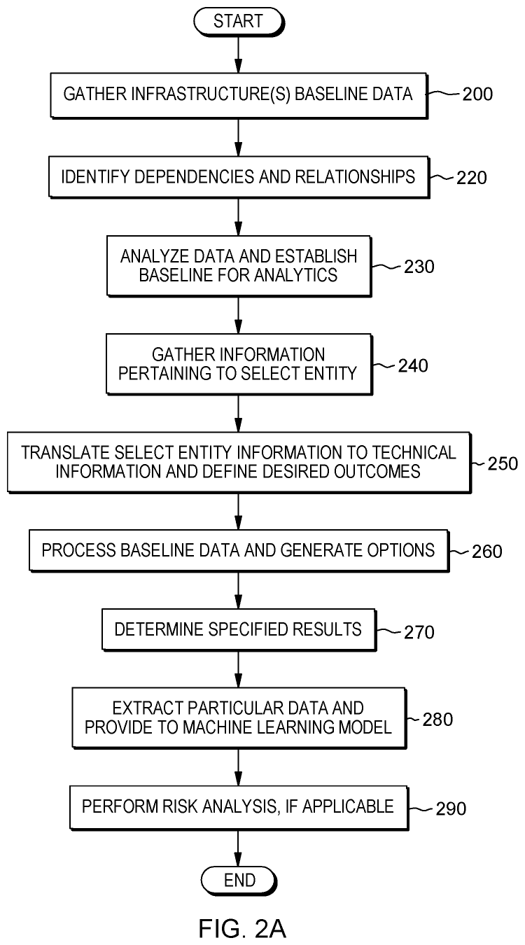

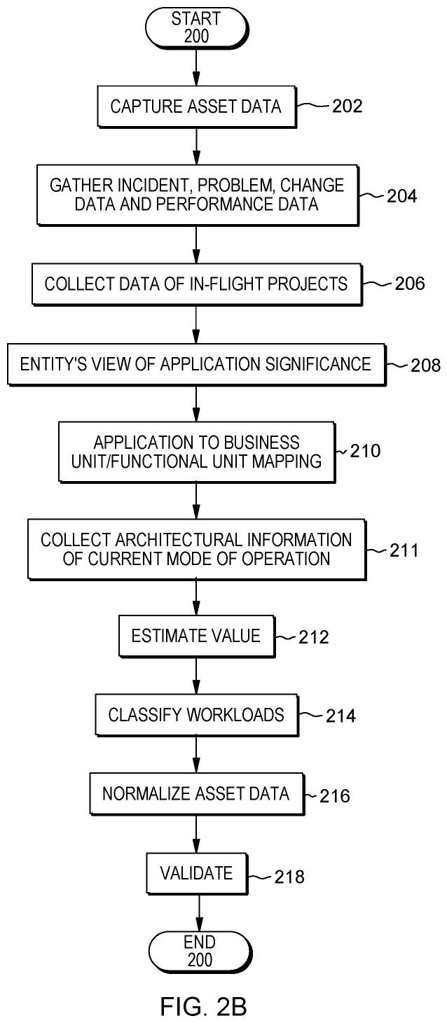

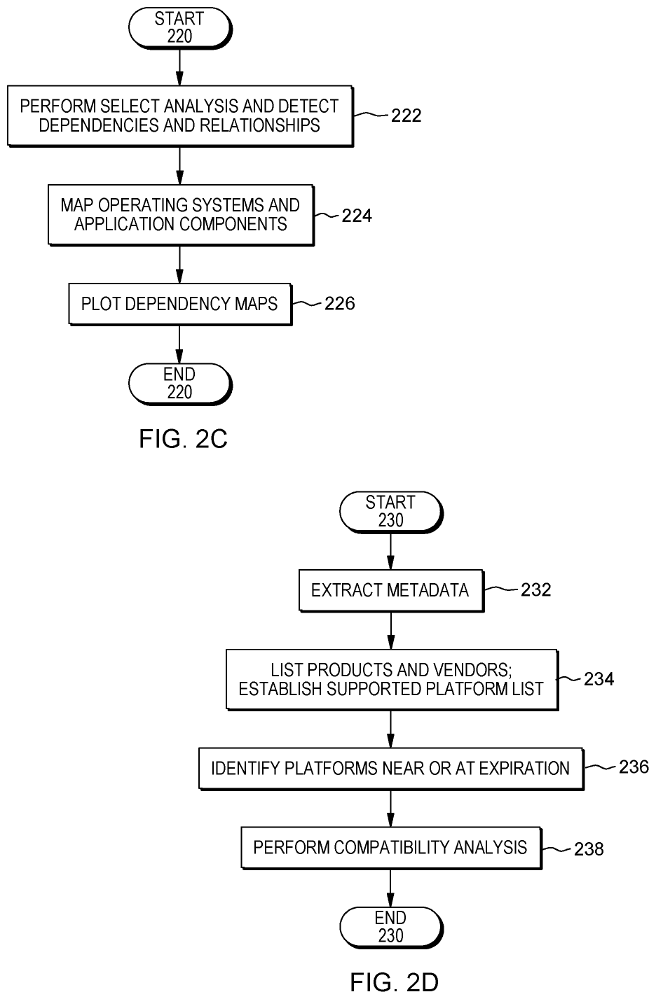

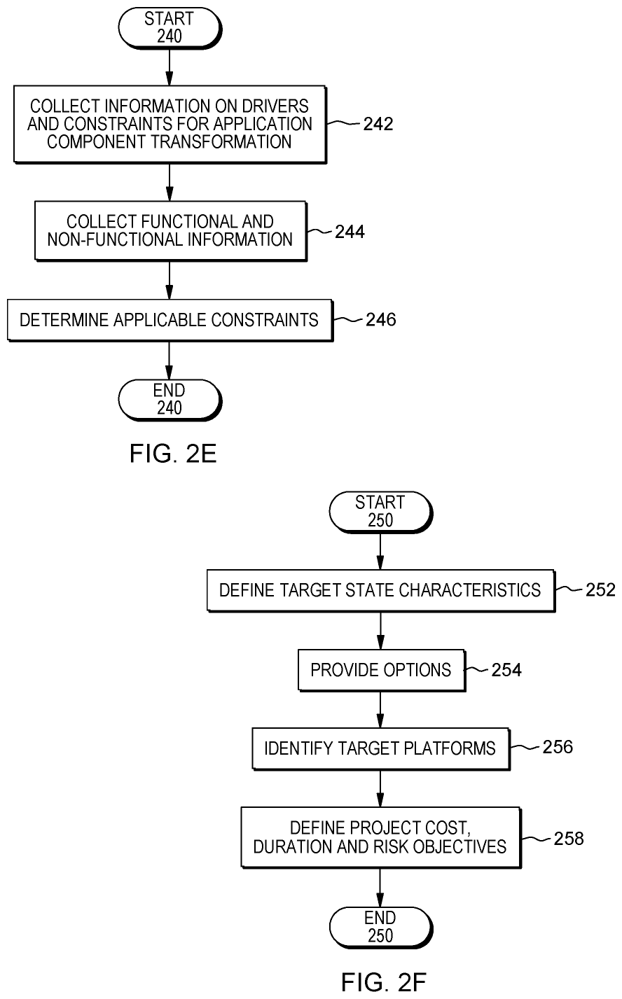

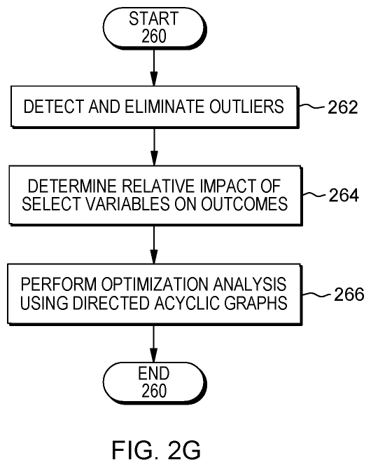

One or more of the computing resources, such as one or more applications, one or more operating systems, etc., may be, for instance, upgraded from a current version to an updated version (or replaced, etc.), which may affect other computing resources of the computing environment. Therefore, in accordance with one or more aspects of the present invention, a transformation technique is provided to transform selected computing resources, and therefore, the computing environment, from one technological state to another technological state. One example of such a transformation technique is described with reference to FIGS. 2A-2G.

In one example, tasks, operations or steps of the technique may be performed by one or more processing circuits, computing tools and/or other tools. The processing circuits and/or tools may be part of, and/or separate but coupled to, a processor, processing unit, processor module, computing environment, etc. For example, data that is collected may be collected using, e.g., one or more graphical user interfaces executed via a processor and/or automatically using, e.g., scripts, modules, programs, etc., executed on a processor. Other examples are also possible.

With reference to FIG. 2A, one embodiment of an overview of a transformation process to be used in transformation of a computing environment, including one or more infrastructures of the computing environment, from one technological state to another technological state is described. In one example, baseline data of one or more infrastructures of the computing environment, including baseline data of an application infrastructure, is collected 200. Further, dependencies and relationships between various computing resources of one or more of the infrastructures are identified 220. The data is analyzed and a baseline for analysis is established 230. Moreover, information pertaining to a select entity (e.g., a select business) as it relates to the one or more infrastructures is obtained 240. The obtained information is translated into technical information and desired outcomes are defined 250. The baseline data (and/or other data) is processed, and one or more transformation options are generated that take into consideration the desired outcomes 260. As part of the processing, optimization analysis is performed using, for instance, directed acyclic graphs. From one or more directed acyclic graphs, at least one optimized upgrade pathway (e.g., set of transformation tasks) provides specified results 270. Additionally, in one or more embodiments, particular data is extracted and provided to a machine learning model, which is used to improve the processing and/or provide predictive processing capabilities 280. Further, in one example, risk analysis is performed 290. Each of the operations of FIG. 2A is further described with reference to FIGS. 2B-2G.

Referring to FIG. 2B, further details with respect to collecting baseline data relating to one or more infrastructures of the computing environments are described. The data is collected using, for instance, one or more tools, such as inventory management tools, performance monitoring/analysis tools and/or cost recovery analysis tools now in existence and/or later developed. For instance, an automated discovery of infrastructure and software components is executed to capture asset data of the computing environment 202. The data includes, for instance, detailed information of server hardware and their configurations including storage environment and network capacity and links, application software components, application services, their quantity, versions, installed sites including cloud deployments, etc. Further, incident, problem and change data, as well as performance data, for the existing environment are collected 204. Additionally, details of current in-flight projects within the computing environment are collected 206. A view from an entity's perspective (e.g., a business perspective) of application significance, e.g., strategic, tactical, declining, etc. is gathered 208 (e.g., from the entity manually; using an application programming interface; etc.), as well as application to business unit/functional unit mapping 210. Also collected is architectural information of the current mode of operation of the environment 211.

In one example, the book value of existing investments in hardware, application software licenses, development and implementation costs is estimated 212. This may be performed, e.g., automatically using, e.g., standard accounting principles/techniques, based on information stored relating to the resources. Further, in one example, the workloads are classified as, e.g., production, development and staging environments 214. The asset data is normalized and cleansed for validation and analysis 216. Further, the data may be validated with, e.g., asset owners and/or others 218.

In addition to collecting the data, returning to FIG. 2A, dependencies and relationships are identified 220. For instance, with reference to FIG. 2C, an analysis, such as a NetFlow analysis, is performed and dependencies and relationships between various infrastructure components, including application components, are detected 222. In one example, operating systems and application software components are mapped to each other and to the host servers (hardware systems) and to locations (sites) 224. Dependency maps are plotted, in one example 226. The mapping may be performed using one or more tools now in existence or later developed.

Further, referring to FIG. 2A, data is analyzed and a baseline for analysis is established 230. One example of this processing is described with reference to FIG. 2D. In one example, metadata pertaining to installed software—e.g., operating systems and application software components; and hardware platforms—e.g., host servers, is extracted from the asset data to analyze the current installation footprint in the computing environment (current mode of operation) 232. Product families and vendors are identified (e.g., listed), and a supported platforms list is established with inputs from vendors and asset owners (the information may be gathered from vendor websites using, e.g., application programming interface calls, web processes, etc.) 234.

From the application metadata that is extracted and product family lists of the existing environment that are identified, processing (e.g., natural language processing) is performed to identify platforms that have reached expiration, those that are heading towards expiration in the near future (for instance, in next 6 to 18 months), and those platforms that have a long useful life remaining 236.

Moreover, in one example, software compatibility analysis is performed using, e.g., scripts, and supported operating system versions are mapped to supported application versions and then to supported hardware platforms 238. A file, referred to as a look up file, is used for analytics and further processing. For instance, based on the dependencies identified in the earlier processing, the compatibility is evaluated for several components serving an application. For example, one server running an “N-2” version operating system is serving an application running a “Y-1” version, and the server is hosted on a storage system running a “Z-2” version. In this case, the compatibility of the operating system version is validated against the application version and storage firmware version. Compatibility table(s) may be obtained from the respective vendor sites and then the scripts may be used to validate the compatibility for several probabilities and combinations that can facilitate deriving the best possible target state versions.

Returning to FIG. 2A, in one example, information pertaining to a select entity (e.g., business requests (e.g., requirements)) is collected 240, as described further with reference to FIG. 2E. For instance, in one embodiment, information on entity drivers and constraints for application component transformation is collected 242. As an example, the following information is collected: anticipated growth of the entity (e.g., business) in the near to medium term; anticipated corresponding growth in information technology (IT) infrastructure to support the growth of the entity; entity and technology roadmap of the organization; critical applications from the standpoint of entity stakeholders; and/or new applications to support the entity, etc. In one example, a graphical user interface and/or scripts, programs, modules, etc. may be used to collect the information.

Additionally, in one example, functional and non-functional requirements for the transformation/modernization/upgrade of one or more infrastructures are collected based on information provided by an entity (e.g., business) 244. These requirements include, for instance, resource and skill constraints; performance, availability, security and regulatory requirements; placement rules for physical and logical components during proposed upgrade approaches; and/or technology currency requirements (version N, N-1, N-2 etc.). Additional, fewer and/or other requirements may be collected.

Moreover, in one example, one or more applicable constraints that may govern the transformation process are determined 246. Example constraints include, for instance, timeline/project duration; cost (budget); and/or risk appetite for changes, downtime etc.

Returning to FIG. 2A, select entity information is translated to technical information and desired outcomes are defined 250, as further described with reference to FIG. 2F. For instance, in one example, desired target state characteristics are defined 252. The target state characteristics include, for instance, processing throughput, business functionality, new features and enhancements criteria, technical resiliency, connectivity and/or integrations. In one example, options in terms of upgrades, transformations (technology replacements) and status quo continuation (i.e., retain/maintain existing platform) for each class of systems are provided 254. Further, in one example, target operating system platforms and versions, application platforms and versions, cloud and non-cloud hosting options, hardware platforms, etc. are identified 256 and project cost, duration and risk objectives are defined 258.

Additionally, returning to FIG. 2A, baseline data is processed, and options, referred to as transformation pathways (e.g., sets of transformation tasks), are generated 260. An example of this processing is described with reference to FIG. 2G. For instance, in one embodiment, outliers in the asset data are detected and eliminated using, e.g., multivariate analysis 262; and the relative impact of select levers (variables) on the outcomes (i.e., impact of project budget, risk appetite and other considerations on selected transformation routes) is gauged using, for instance, multilinear regression analysis 264.

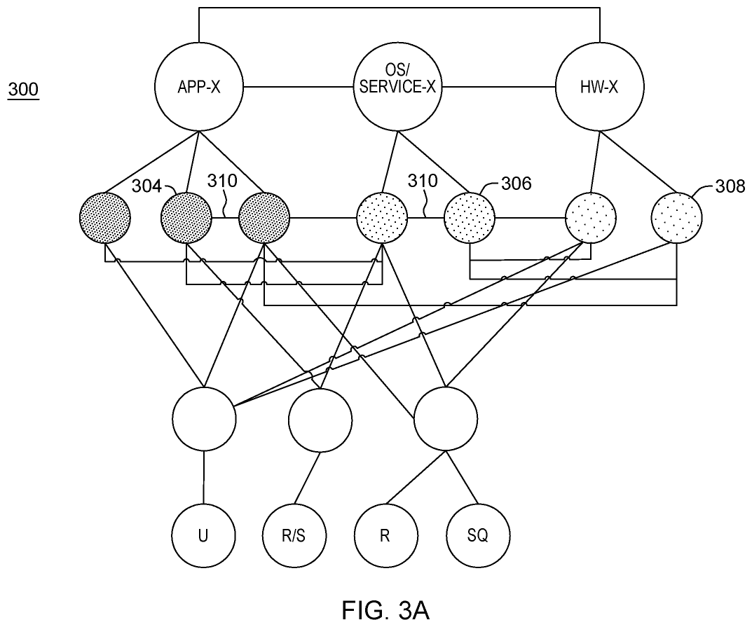

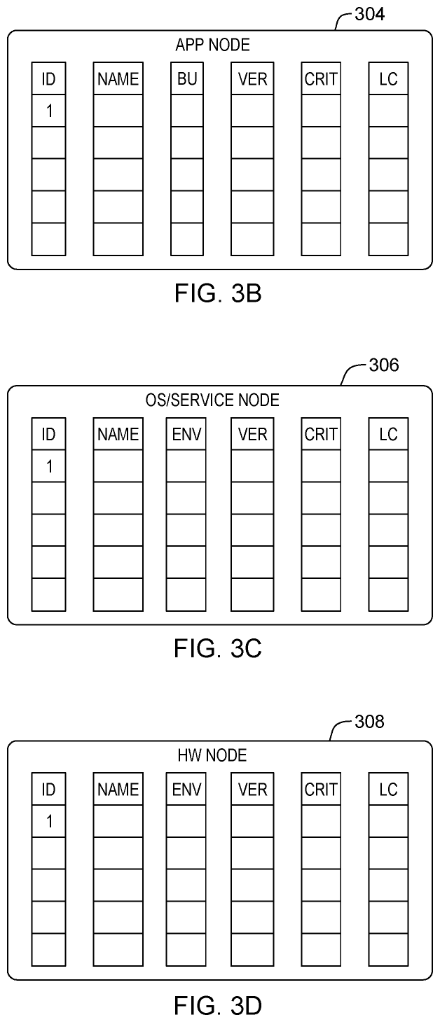

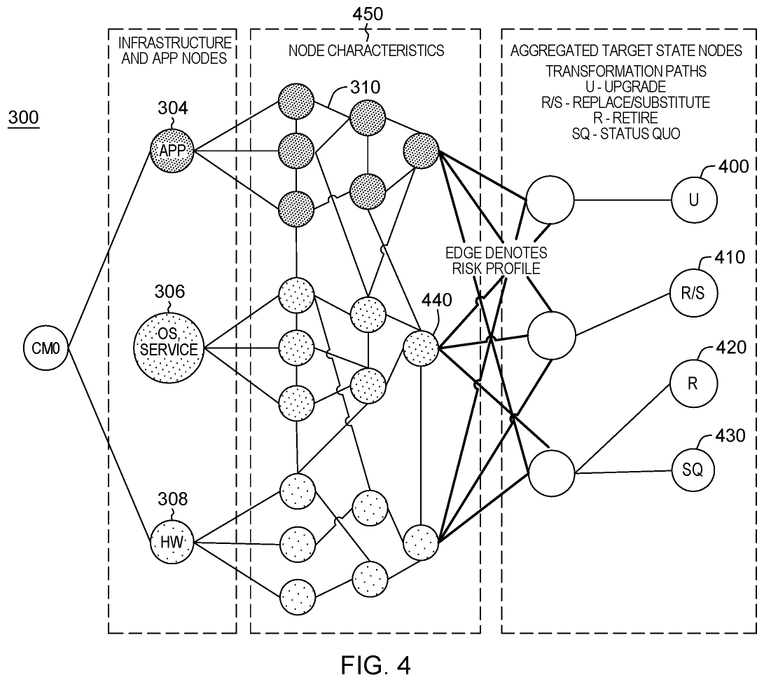

Moreover, in one example, optimization analysis is performed using, e.g., directed acyclic graphs 266, examples of which are depicted in FIGS. 3A and 4. For instance, a graphical model with a current mode of operation and a future mode of operation as the start and end points is plotted. In one example, each variable becomes a node in a graph 300. For instance, nodes 304 represent application component platforms and versions (also see FIG. 3B depicting application nodes and example characteristics—e.g., identifier of application, name of application, business unit, version of application, criticality level of application for the entity, life-cycle status of application (e.g., fully functional and current, nearing out of support but functional, not functional and out of support, etc.), and/or other characteristics), nodes 306 represent server operating system platforms and versions (also see FIG. 3C depicting operating system nodes and example characteristics—e.g., identifier, name, environment, version, criticality level for the entity, life-cycle status, and/or other characteristics), and nodes 308 represent hardware platforms (also see FIG. 3D depicting hardware nodes and example characteristics—e.g., identifier, name, environment, version, criticality level for the entity, life-cycle status, and/or other characteristics), respectively.

In one example, each edge 310 connecting the nodes represents a characteristic 450 (FIG. 4) or consideration that is to be accounted for; an edge can represent multiple considerations that are weighted based on entity (e.g., business) inputs. Where technical and non-technical considerations cause a pathway (a graphical connection from left to right) to stop before reaching a future mode of operation, it represents a pathway that is to be discarded. Based on the nodes being plotted in many-to-many relationships with appropriate edge weights, the graph is complete. The pathways (e.g., sets of transformation tasks) that meet the prioritized objectives (e.g., quickest time/lowest cost/least risk/maximum features and functionality, etc., or a combination of select objectives) represent viable pathways for modernization or transformation. The pathway that is shortest in length or has the highest edge weight is the optimal transformation pathway, in one example. Directional acyclic graphs facilitate what-if analysis by allowing for adding or changing criteria to determine the corresponding outcome and making informed decisions.

In performing optimization, various optimization vectors may be used, including, for instance, cost optimization—e.g., number of software licenses saved, prevented rollbacks and transformation failures avoided; effort optimization—e.g., efficiency gained in rigorous data-driven analysis versus manual processes in use today, savings in the number of hours expended; and/or technology optimization—e.g., platform consolidation, custom upgrade paths based on the type of workloads and currency needs. Additional, fewer and/or other optimization vectors may be used.

Returning to FIG. 2A, results are provided 270. For instance, from the directional acyclic graph (e.g., FIGS. 3A, 4), an optimized upgrade pathway reveals the following, as examples: list of application components to be upgraded 400 (FIG. 4); application components to be replaced or substituted 410; application components to be retired 420; status quo (retained as-is) versions of application components 430; target operating systems 440 which will support the application components; sequence and grouping of application components to execute upgrades with minimal business impact; optimized bill of materials that minimizes cost of product licenses and helps execute the program without unwanted rollbacks; project cost and duration for the upgrade pathway; and/or if different from the future mode of operation, further steps to reach future mode of operation. Additional, fewer and/or other results may be obtained.

Moreover, referring to FIG. 2A, in one example, particular data is extracted and provided to, e.g., a machine learning model 280. As an example, from a modernization/transformation project—environmental data, implementation goals and objectives, select decisions and outcomes are extracted, anonymized and stored in a data repository, such as a data lake, for feeding to a machine learning model to help improve future programs. Machine learning or deep learning, an aspect of artificial intelligence, is used in various technologies, including, but not limited to, computer processing, engineering, manufacturing, medical technologies, automotive technologies, etc. to improve certain processing.

In one example, a neural network, a subset of machine learning, uses training data to learn and improve its accuracy. A neural network includes a plurality of node layers, including, for instance, an input layer, one or more hidden layers and an output layer. Each node (also referred to as a neuron) connects to another node and has a weight and bias associated therewith. The weights and biases are learnable parameters of the neural network. When the inputs are transmitted between the nodes, the weights are applied to the inputs along with the biases. If an output of a node is above the bias, the node is activated, sending data to the next layer of the neural network. If, however, the node is not above the bias, then n data is passed along to the next layer. Further, in one example, the weights and biases are optimized.

Further, in one embodiment, risk analysis may be performed, if applicable 290. For instance, the risk level of a workload is related to both the currency and likelihood of failure of the hardware, operating system, software components and/or running applications. This risk level may change when any of these are upgraded, and therefore the risks are to be modeled to inform the approach to the work as an optimal upgrade path is derived.

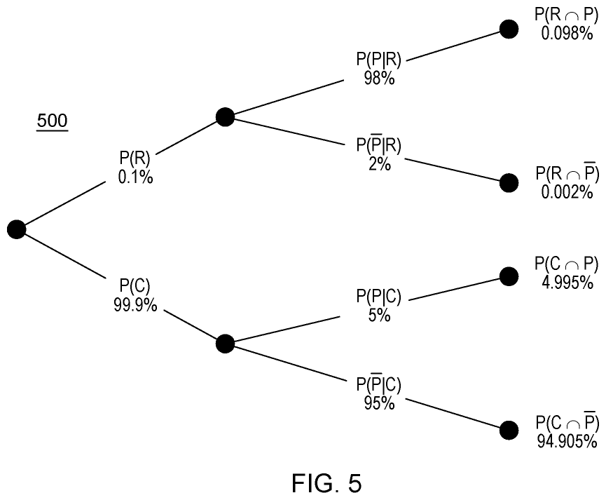

To model the risks, in one example, Bayes' theorem for risk analysis is employed. Referring to FIG. 5, a tree diagram 500 illustrates an example of Bayes' theorem. In this diagram, R is the event that an n-1 application fails; C is the event that an application running on an old operating system will fail; P is the event that an application utilizing an old storage platform will fail; and P bar (P̅) is the event that the application utilizes non-selected storage platforms (e.g., non-IBM® storage platforms). IBM is a registered trademark or trademark of International Business Machines Corporation in at least one jurisdiction.

The overall analysis may be complex, but a risk rating can be produced if the application currency, hardware platforms, failure conditions etc. are known and/or can be estimated. In one example, the percentages shown in parentheses are the calculated risks; and an optimum path depends, for instance, on the client's choice and preferences; and there are many ways to perform optimization (e.g., a multivariate optimization may be performed, for example, by a Laplace Transform).

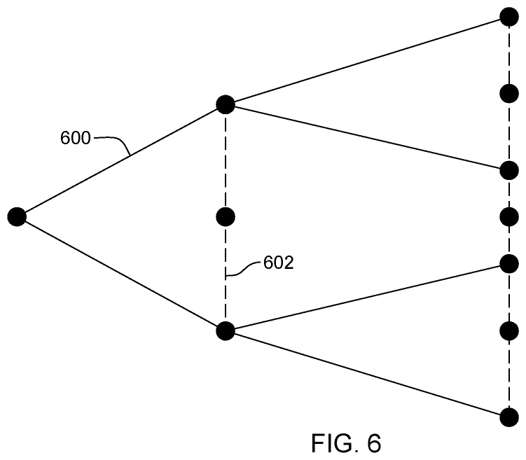

As shown in FIG. 6, in one example, risk profiles of the nodes are shown with solid lines 600 and hidden Markov probabilities of events impacting the risk of nodes are shown with dotted lines 602.

Given the parameters of a model, the probability of a particular output sequence is computed. This includes a summation over all (or select) possible state sequences:

The probability of observing a sequence

Y=y(0),y(1), . . . ,y(L−1)

of length L is given by

$$P ( Y ) = {{\sum }_{x}}^{n} P ( Y \vert X ) P ( X ) ,$$

where the sum runs over all possible hidden-node sequences

X=x(0),x(1), . . . ,x(L−1).

Applying the principle of dynamic programming, this problem may also be handled efficiently using a forward algorithm.

A Bayesian approach allows for starting with an estimate of the probability that can be subsequently refined by observation. Added into this is a hidden Markov chain, which allows an observation of not only the measurable events but the hidden events. In one example, three general models (likelihood, decoding, and learning) are utilized to start the hidden Markov process. A change is made to the general mathematics, since an attempt is being made to optimize the risk ratio to an input provided by, e.g., the client. Traditional Markovian mathematics calculates the probability.

Although particular techniques are mentioned herein, additional, fewer and/or other techniques may be used in one or more aspects.

Described herein is a refined approach to transform one or more infrastructures (e.g., an application infrastructure) of a computing environment from one technological state to another technological state.

Presently application modernization in large information technology environments calls for involvement of multiple domain experts, extensive data gathering and analysis from multiple sources and decision making in a labor and time intensive, failure-prone process. Missed activities in initial planning and the exclusion of their cost estimates also cause budget overruns. However, one or more aspects of the present invention provides a solution by providing for data-driven, cognitive analytics based transformation pathways (which include modernization, substitution and scalability) taking into consideration related variables. The result is an optimized application upgrade and modernization path (e.g., a set of transformation tasks) that can be executed at scale avoiding the error-prone manual techniques in use today.

One or more aspects: take into consideration multiple business and technical criteria and reconcile them in a logical way in application transformation and modernization projects; automatically derive a set of potential transformation and modernization paths which use a set of factors including, but not limited to: expected monetary cost of the program/initiative, expected time to complete the program/initiative, length of time that selected software components remain in support after upgrade is complete, access to new functionality enabled by the upgrade program; expected impact on current and projected license costs for software components (e.g., potential license cost optimization; impact on the security and compliance posture of the organization as a result of the upgrade (e.g., how it addresses known security vulnerabilities in the existing versions), technology currency requirements of the business, ability to tolerate risk, i.e., risk appetite (e.g., risks of postponing an upgrade/modernization); provide an ability to prioritize and make decisions on identified factors to generate optimal transformation/modernization plans; customize upgrade/modernization paths for various categories of systems (production vs. development workloads—e.g., for development environment a recent or latest operating system version might be suggested in order to test future releases, whereas for production systems stable, matured versions are recommended); benefits versus trade-offs views for each modernization path enabling effective scenario planning and finally; and/or execution of transformation projects within planned budgets and timelines by preventing unplanned, unwanted cost/time overruns.

In one or more aspects, the multi-dimensional impact (impact of the upgrades and benefits of alternate target platforms and versions) is rapidly assessed, and a plan is provided that reduces the need for rollbacks during transformation projects which have huge cost implications and cause significant disruption to business. An optimized modernization plan enables businesses to move from a current mode of operation to, e.g., an optimized mode of operation (e.g., ability to utilize an N-1 version) enroute to, e.g., a future mode of operation, at a predictable cost.

In one or more aspects, at least one set of transformation tasks is derived that is used to transform a selected infrastructure (e.g., an application infrastructure) from one technological state to another technological state (e.g., an upgraded state). Based on the at least one set of transformation tasks, one or more actions are performed to transform the selected infrastructure. For instance, an upgrade or replacement of an application may be initiated. Additional, fewer and/or other actions may be performed.

One or more aspects of the present invention are inextricably tied to computer technology and facilitate processing within a computer, improving performance thereof. The use of a process to automatically transform a computing environment from one technological state to another technological state reduces complexity within a computing environment and improves processing.

Although embodiments are described herein, other variations and embodiments are possible.

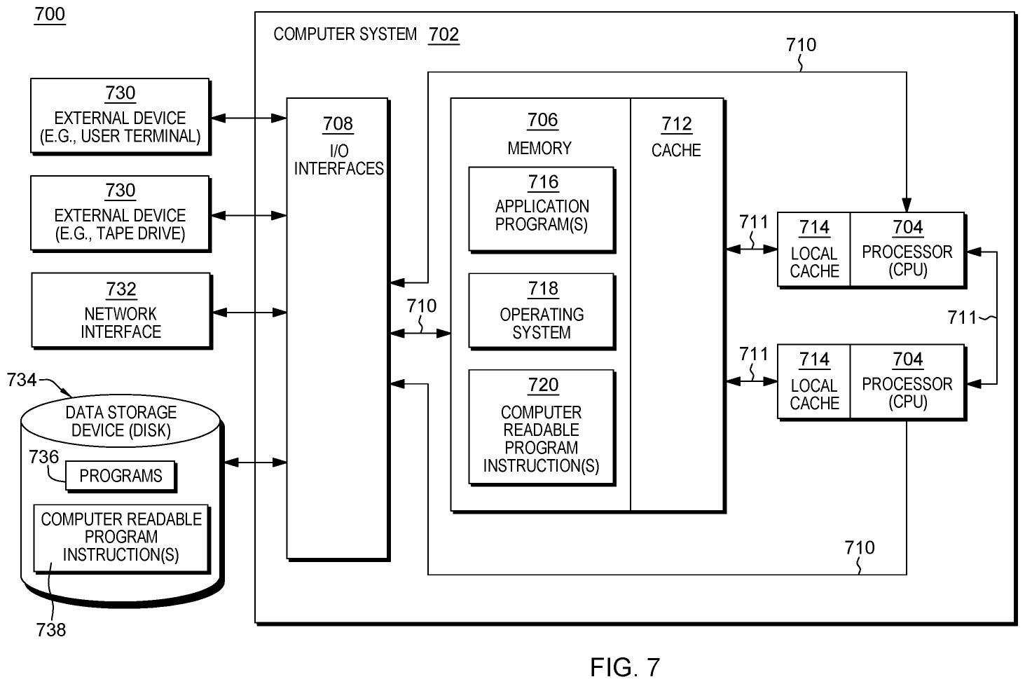

One or more aspects of the present invention may be incorporated and/or used in many computing environments. One embodiment of a computing environment to incorporate and use one or more aspects of the present invention is described with reference to FIG. 7. As shown in FIG. 7, a computing environment 700 includes, for instance, a computer system 702 shown, e.g., in the form of a general-purpose computing device. Computer system 702 may include, but is not limited to, one or more processors or processing units 704 (e.g., central processing units (CPUs) and/or special-purpose processors, etc.), a memory 706 (a.k.a., system memory, main memory, main storage, central storage or storage, as examples), and one or more input/output (I/O) interfaces 708, coupled to one another via one or more buses and/or other connections. For instance, processors 704 and memory 706 are coupled to I/O interfaces 708 via one or more buses 710, and processors 704 are coupled to one another via one or more buses 711.

Bus 711 is, for instance, a memory or cache coherence bus, and bus 710 represents one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI).

Memory 706 may include, for instance, a cache 712, such as a shared cache, which may be coupled to local caches 714 of processors 704 via, e.g., one or more buses 711. Further, memory 706 may include one or more programs or applications 716, at least one operating system 718, and one or more computer readable program instructions 720. Computer readable program instructions 720 may be configured to carry out functions of embodiments of aspects of the invention.

Computer system 702 may communicate via, e.g., I/O interfaces 708 with one or more external devices 730, such as a user terminal, a tape drive, a pointing device, a display, and one or more data storage devices 734, etc. A data storage device 734 may store one or more programs 736, one or more computer readable program instructions 738, and/or data, etc. The computer readable program instructions may be configured to carry out functions of embodiments of aspects of the invention.

Computer system 702 may also communicate via, e.g., I/O interfaces 708 with network interface 732, which enables computer system 702 to communicate with one or more networks, such as a local area network (LAN), a general wide area network (WAN), and/or a public network (e.g., the Internet), providing communication with other computing devices or systems.

Computer system 702 may include and/or be coupled to removable/non-removable, volatile/non-volatile computer system storage media. For example, it may include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media. It should be understood that other hardware and/or software components could be used in conjunction with computer system 702. Examples, include, but are not limited to: microcode, device drivers, redundant processing units, external disk drive arrays, RAID systems, tape drives, and data archival storage systems, etc.

Computer system 702 may be operational with numerous other general-purpose or special purpose computing system environments or configurations. Examples of well-known computing systems, environments, and/or configurations that may be suitable for use with computer system 702 include, but are not limited to, personal computer (PC) systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

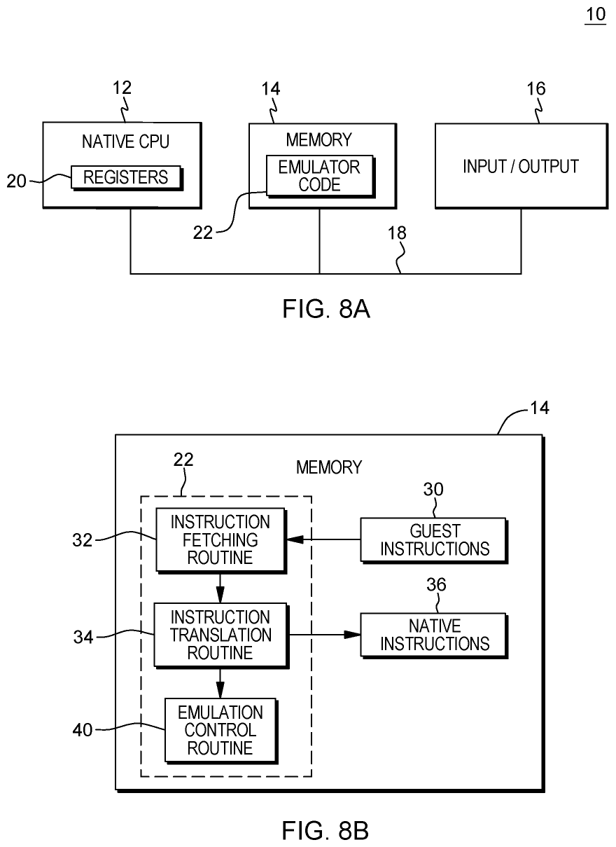

Another embodiment of a computing environment to incorporate and use one or more aspects of the present invention is described with reference to FIG. 8A. In this example, a computing environment 10 includes, for instance, a native central processing unit (CPU) 12, a memory 14, and one or more input/output devices and/or interfaces 16 coupled to one another via, for example, one or more buses 18 and/or other connections. As examples, computing environment 10 may include an IBM® Power® processor offered by International Business Machines Corporation, Armonk, N.Y.; an HP Superdome with Intel® processors offered by Hewlett Packard Co., Palo Alto, Calif.; and/or other machines based on architectures offered by International Business Machines Corporation, Hewlett Packard, Intel Corporation, Oracle, or others. Power is a trademark or registered trademark of International Business Machines Corporation in at least one jurisdiction. Intel is a trademark or registered trademark of Intel Corporation or its subsidiaries in the United States and other countries.

Native central processing unit 12 includes one or more native registers 20, such as one or more general purpose registers and/or one or more special purpose registers used during processing within the environment. These registers include information that represents the state of the environment at any particular point in time.

Moreover, native central processing unit 12 executes instructions and code that are stored in memory 14. In one particular example, the central processing unit executes emulator code 22 stored in memory 14. This code enables the computing environment configured in one architecture to emulate another architecture. For instance, emulator code 22 allows machines based on architectures other than, e.g., the IBM® z/Architecture® instruction set architecture, such as Power processors, HP Superdome servers or others, to emulate the z/Architecture instruction set architecture and to execute software and instructions developed based on the z/Architecture instruction set architecture. z/Architecture is a trademark or registered trademark of International Business Machines Corporation in at least one jurisdiction.

Further details relating to emulator code 22 are described with reference to FIG. 8B. Guest instructions 30 stored in memory 14 comprise software instructions (e.g., correlating to machine instructions) that were developed to be executed in an architecture other than that of native CPU 12. For example, guest instructions 30 may have been designed to execute on a processor based on the z/Architecture instruction set architecture, but instead, are being emulated on native CPU 12, which may be, for example, an Intel Itanium II processor. In one example, emulator code 22 includes an instruction fetching routine 32 to obtain one or more guest instructions 30 from memory 14, and to optionally provide local buffering for the instructions obtained. It also includes an instruction translation routine 34 to determine the type of guest instruction that has been obtained and to translate the guest instruction into one or more corresponding native instructions 36. This translation includes, for instance, identifying the function to be performed by the guest instruction and choosing the native instruction(s) to perform that function.

Further, emulator code 22 includes an emulation control routine 40 to cause the native instructions to be executed. Emulation control routine 40 may cause native CPU 12 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 36 may include loading data into a register from memory 14; storing data back to memory from a register; or performing some type of arithmetic or logic operation, as determined by the translation routine.

Each routine is, for instance, implemented in software, which is stored in memory and executed by native central processing unit 12. In other examples, one or more of the routines or operations are implemented in firmware, hardware, software or some combination thereof. The registers of the emulated processor may be emulated using registers 20 of the native CPU or by using locations in memory 14. In embodiments, guest instructions 30, native instructions 36 and emulator code 22 may reside in the same memory or may be disbursed among different memory devices.

The computing environments described above are only examples of computing environments that can be used. Other environments, including but not limited to, non-partitioned environments, partitioned environments, cloud environments and/or emulated environments, may be used; embodiments are not limited to any one environment. Although various examples of computing environments are described herein, one or more aspects of the present invention may be used with many types of environments. The computing environments provided herein are only examples.

Each computing environment is capable of being configured to include one or more aspects of the present invention. For instance, each may be configured to perform one or more actions to transform one or more infrastructures of a computing environment from one technological state to another technological state, in accordance with one or more aspects of the present invention.

Although various embodiments are described herein, many variations and other embodiments are possible without departing from a spirit of aspects of the present invention. It should be noted that, unless otherwise inconsistent, each aspect or feature described herein, and variants thereof, may be combinable with any other aspect or feature.

One or more aspects may relate to cloud computing.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

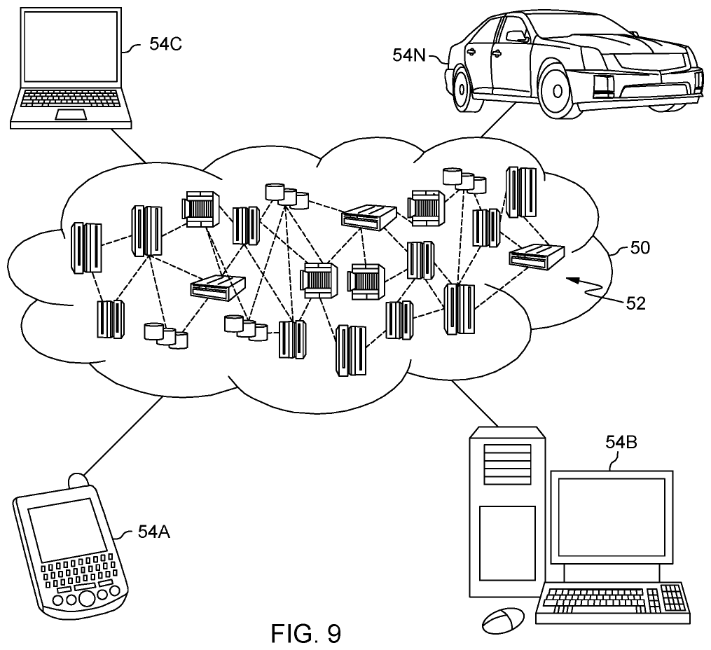

Referring now to FIG. 9, illustrative cloud computing environment 50 is depicted. As shown, cloud computing environment 50 includes one or more cloud computing nodes 52 with which local computing devices used by cloud consumers, such as, for example, personal digital assistant (PDA) or cellular telephone 54A, desktop computer 54B, laptop computer 54C, and/or automobile computer system 54N may communicate. Nodes 52 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 52 and cloud computing environment 50 can communicate with any type of computerized device over any type of network and/or network addressable connection (e.g., using a web browser).

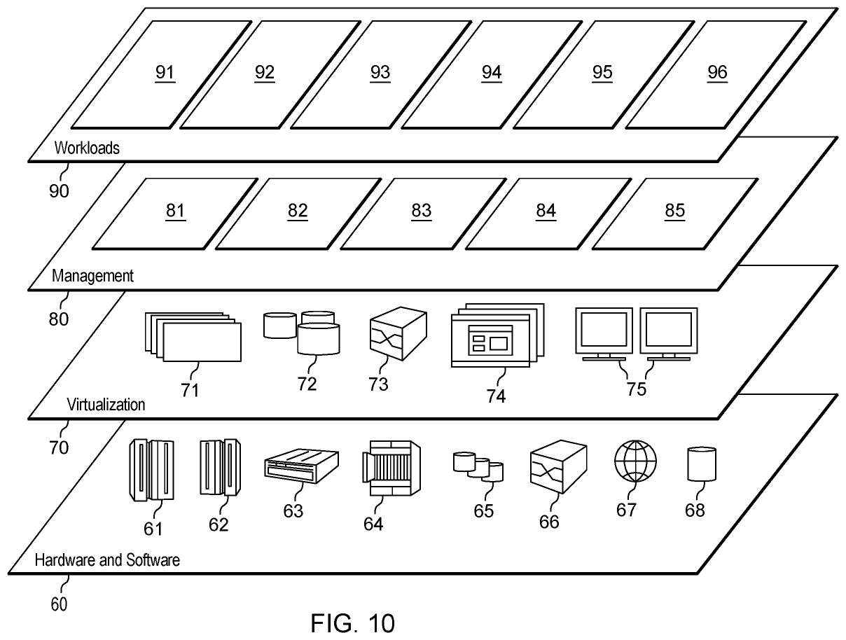

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and technological transformation processing 96.

Aspects of the present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, different types of operations and/or techniques be employed. Many variations are possible.

Various aspects are described herein. Further, many variations are possible without departing from a spirit of aspects of the present invention. It should be noted that, unless otherwise inconsistent, each aspect or feature described herein, and variants thereof, may be combinable with any other aspect or feature.

Further, other types of computing environments can benefit and be used. As an example, a data processing system suitable for storing and/or executing program code is usable that includes at least two processors coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product for facilitating processing within a computing environment, the computer program product comprising:
one or more computer readable storage media and program instructions collectively stored on the one or more computer readable storage media to perform a method comprising:
obtaining data relating to the computing environment, the data including life-cycle information of one or more computing resources of the computing environment and one or more requests of an entity to use the computing environment;
automatically deriving, based at least on the data that is obtained, a plurality of sets of transformation tasks to be used to transform a selected infrastructure of the computing environment from one technological state to another technological state; and
performing one or more actions, based on at least one set of transformation tasks of the plurality of sets of transformation tasks, to transform the selected infrastructure from the one technological state to the other technological state.

2. The computer program product of claim 1, wherein the selected infrastructure includes an application infrastructure that includes one or more applications.

3. The computer program product of claim 1, wherein the one technological state is a current state having one set of applications and the other technological state is a future state having another set of applications.

4. The computer program product of claim 1, wherein the data includes application life-cycle information for one or more applications of the computing environment.

5. The computer program product of claim 1, wherein the obtaining data comprises executing an automated discovery of the computing environment to obtain resource data relating to a plurality of computing resources of the computing environment, the plurality of computing resources including one or more applications, one or more operating systems and one or more servers.

6. The computer program product of claim 1, wherein the method further comprises:
extracting metadata from the data that is obtained to analyze a current mode of operation of the computing environment;
determining, based on the metadata that is extracted, the life-cycle information for the one or more computing resources of the computing environment;
determining one or more technical requirements based on the one or more requests of the one or more entities, and
wherein the automatically deriving the plurality of sets of transformation tasks is based on at least a portion of the metadata, life-cycle information and technical requirements.

7. The computer program product of claim 1, wherein the method further includes using at least one of multiple linear regression analysis and optimization analysis to select at least one set of transformation tasks of the plurality sets of transformation tasks as the set of transformation tasks to be used to transform the selected infrastructure.

8. The computer program product of claim 1, where the method further comprises performing analysis of at least one set of transformation tasks of the plurality of sets of transformation tasks to determine predictable outcomes of transforming the selected infrastructure from the one technological state to the other technological state.

9. The computer program product of claim 1, wherein the method further comprises performing risk modelling of one or more sets of transformation tasks of the plurality of sets of transformation tasks to determine at least one set of transformation tasks of the plurality of sets of transformation tasks to be used in transformation.

10. The computer program product of claim 1, wherein the performing one or more actions includes initiating transformation of the selected infrastructure, wherein the initiating transformation includes initiating replacement of one version of an application with another version of the application.

11. A computer system for facilitating processing within a computing environment, the system comprising:
a memory; and
at least one processor in communication with the memory, wherein the computer system is configured to perform a method, said method comprising:
obtaining data relating to the computing environment, the data including life-cycle information of one or more computing resources of the computing environment and one or more requests of an entity to use the computing environment;
automatically deriving, based at least on the data that is obtained, a plurality of sets of transformation tasks to be used to transform a selected infrastructure of the computing environment from one technological state to another technological state; and
performing one or more actions, based on at least one set of transformation tasks of the plurality of sets of transformation tasks, to transform the selected infrastructure from the one technological state to the other technological state.

12. The computer system of claim 11, wherein the obtaining data comprises executing an automated discovery of the computing environment to obtain resource data relating to a plurality of computing resources of the computing environment, the plurality of computing resources including one or more applications, one or more operating systems and one or more servers.

13. The computer system of claim 11, wherein the method further comprises:
extracting metadata from the data that is obtained to analyze a current mode of operation of the computing environment;
determining, based on the metadata that is extracted, the life-cycle information for the one or more computing resources of the computing environment;
determining one or more technical requirements based on the one or more requests of the one or more entities, and
wherein the automatically deriving the plurality of sets of transformation tasks is based on at least a portion of the metadata, life-cycle information and technical requirements.

14. The computer system of claim 11, wherein the method further includes using at least one of multiple linear regression analysis and optimization analysis to select at least one set of transformation tasks of the plurality sets of transformation tasks as the set of transformation tasks to be used to transform the selected infrastructure.

15. The computer system of claim 11, where the method further comprises performing analysis of at least one set of transformation tasks of the plurality of sets of transformation tasks to determine predictable outcomes of transforming the selected infrastructure from the one technological state to the other technological state.

16. A computer-implemented method of facilitating processing within a computing environment, the computer-implemented method comprising:
obtaining data relating to the computing environment, the data including life-cycle information of one or more computing resources of the computing environment and one or more requests of an entity to use the computing environment;
automatically deriving, based at least on the data that is obtained, a plurality of sets of transformation tasks to be used to transform a selected infrastructure of the computing environment from one technological state to another technological state; and
performing one or more actions, based on at least one set of transformation tasks of the plurality of sets of transformation tasks, to transform the selected infrastructure from the one technological state to the other technological state.

17. The computer-implemented method of claim 16, wherein the obtaining data comprises executing an automated discovery of the computing environment to obtain resource data relating to a plurality of computing resources of the computing environment, the plurality of computing resources including one or more applications, one or more operating systems and one or more servers.

18. The computer-implemented method of claim 16, further comprising:
extracting metadata from the data that is obtained to analyze a current mode of operation of the computing environment;
determining, based on the metadata that is extracted, the life-cycle information for one or more computing resources of the computing environment;
determining one or more technical requirements based on the one or more requests of the one or more entities, and
wherein the automatically deriving the plurality of sets of transformation tasks is based on at least a portion of the metadata, life-cycle information and technical requirements.

19. The computer-implemented method of claim 16, further including using at least one of multiple linear regression analysis and optimization analysis to select at least one set of transformation tasks of the plurality sets of transformation tasks as the set of transformation tasks to be used to transform the selected infrastructure.

20. The computer-implemented method of claim 16, further comprising performing analysis of at least one set of transformation tasks of the plurality of sets of transformation tasks to determine predictable outcomes of transforming the selected infrastructure from the one technological state to the other technological state.
